(19) United States
(12) Patent Application Publication
(10) Pub. No.: US 2023/0266468 A1
(43) Pub. Date: Aug. 24, 2023

(54) Track Association Method and System for Tracking Objects

(71) Applicants: Hyundai Motor Company, Seoul (KR); Kia Corporation, Seoul (KR)

(72) Inventors: Yoon Suk Jang, Seoul (KR); Min Kyun Yoo, Seoul (KR); Hyun Ju Kim, Yongin-si (KR)

(21) Appl. No.: 17/881,053

(22) Filed: Aug. 4, 2022

(30) Foreign Application Priority Data
Feb. 18, 2022 (KR) 10-2022-0021320

(51) Int. Cl. G01S 17/66; G01S 17/931

(52) U.S. Cl. CPC G01S 17/66; G01S 17/931

(57) ABSTRACT

An embodiment method for tracking objects includes generating a plurality of predicted tracks from a plurality of track information generated in a previous step, generating link relationships between a plurality of object boxes detected in a current step and the plurality of predicted tracks, based on associations between the plurality of object boxes and the plurality of predicted tracks, and determining one of the two or more predicted tracks, based on association scores between the two or more predicted tracks and an object box having the link relationships with two or more predicted tracks among the plurality of predicted tracks, and associating the determined one of the two or more predicted tracks with a track of the object box having the link relationships.

### CROSS-REFERENCE TO RELATED APPLICATIONS

This application claims the benefit of Korean Patent Application No. 10-2022-0021320, filed on Feb. 18, 2022, which application is hereby incorporated herein by reference.

### TECHNICAL FIELD

The present invention relates to a track association method and system for tracking objects of a vehicle.

### BACKGROUND

In order to achieve safe autonomous driving of a vehicle, technology that can accurately recognize a surrounding environment, i.e., objects around the vehicle, is required.

Therefore, the vehicle may be provided with various sensor devices, cameras, radar and/or LiDAR, and technology that detects, tracks and/or classifies objects around the vehicle based on sensor data acquired through the sensor devices is applied to the vehicle.

Conventionally, in order to track an object, technology was developed that tracks the object using an association method in which a rectangular box, i.e., an object box, corresponding to the object is generated based on LiDAR data received through LiDAR, i.e., point data, generates a track including an estimated position value of the object based on the object box, and maintains the generated track.

For example, in the conventional association method, tracks generated in the previous step (step T) are predicted in the current step (step T+1), object boxes corresponding to objects are generated in the current step, and the tracks predicted in the current step are associated with the generated object boxes so that the tracks generated in the previous step are updated. Here, in association between the tracks predicted in the current step and the generated object boxes, in order to maintain the tracking identifications (IDs) of the tracks (or referred to as LiDAR tracks), reliabilities of the respective tracks are calculated, and priorities of the respective tracks are determined based on the calculated reliabilities thereof.

Further, in the conventional association method, the tracks and the generated object boxes are associated with each other by calculating associations between the tracks and the generated object boxes based on the determined priorities.

Such a conventional association method is subordinate to the reliabilities of the tracks, and thus, a track may be associated with an object box which does not actually match the corresponding track.

For example, in the conventional association method, a track having a high priority has a much wider choice to determine whether or not to be associated with object boxes generated so as to correspond to objects than a track having a low priority.

Accordingly, when tracks are associated with object boxes through the conventional association method, a situation in which one track having a high priority matches not only a corresponding object box but also all of other object boxes may arise.

For example, in the conventional association method, since the priorities of respective tracks are determined based on the reliabilities of the respective tracks, when there is an error in calculation of the reliabilities of the respective tracks, an error in association between the tracks and the object boxes may also occur, and consequently, an erroneous result product may be output.

Further, depending on the error in calculation of the reliabilities of the tracks, when a situation in which one track matches a plurality of object boxes generated so as to correspond to a plurality of objects arises, the remaining tracks may not match the object boxes generated so as to correspond to the objects, and may be eliminated.

### SUMMARY

Accordingly, embodiments of the present invention provide a track association method and system for tracking objects that substantially obviate one or more problems due to limitations and disadvantages of the related art.

An embodiment of the present invention provides a track association method and system for tracking objects which may provide a many-to-many association structure so that each of a plurality of tracks may be associated with a corresponding one of object boxes corresponding to a plurality of objects, while overcoming structural limits of a conventional one-to-many association structure allowing one track to be associated with object boxes corresponding to a plurality of objects.

Another embodiment of the present invention provides a track association method and system for tracking objects which may apply a linked list to implementation of a many-to-many association structure so as to minimize an expected increase in the amount of computation and to minimize the capacity of a memory.

Additional advantages, objects, and features of embodiments of the invention will be set forth in part in the description which follows and in part will become apparent to those having ordinary skill in the art upon examination of the following, or may be learned from practice of the invention. The objectives and other advantages of the invention may be realized and attained by the structure particularly pointed out in the written description and claims hereof as well as the appended drawings.

In accordance with embodiments of the invention, a track association method for tracking objects includes generating a plurality of predicted tracks from a plurality of track information generated in a previous step, generating link relationships between a plurality of object boxes detected in a current step and the plurality of predicted tracks, based on associations between the plurality of object boxes and the plurality of predicted tracks, determining, depending on association scores between an object box having the link relationships with two or more predicted tracks among the plurality of predicted tracks, and the two or more predicted tracks, one of the two or more predicted tracks, and associating the determined one of the two or more predicted tracks with a track of the object box having the link relationships.

The link relationships may be generated by recording an object box having the associations with each of the plurality of predicted tracks as an association candidate, and recording information of another predicted track having the associations with the association candidate.

The generating the link relationships may include sequentially matching information of an object box determined as the association candidate of each of a first predicted track and a second predicted track included in the plurality of predicted tracks with each of the first predicted track and the second predicted track, identifying the first predicted track based on the information of the object box determined as the association candidate of the second predicted track, matching link information of the identified first predicted track with a front link of the object box determined as the association candidate of the second predicted track, and matching link information of the second predicted track to a rear link of the object box determined as the association candidate of the first predicted track.

The generating the link relationships may further include identifying the link information of the second predicted track matched with the rear link of the object box determined as the association candidate of the first predicted track, based on information of an object box determined as the association candidate of a third predicted track included in the plurality of predicted tracks, identifying a rear link of the object box determined as the association candidate of the second predicted track, based on the link information of the second predicted track, matching link information of the third predicted track with a rear link of the object box determined as the association candidate of the second predicted track based on a fact that any link information is not recorded in the rear link of the object box determined as the association candidate of the second predicted track, and matching the link information of the second predicted track to a front link of the object box determined as the association candidate of the third predicted track.

The two or more predicted tracks used as targets to calculate the association scores may be identified through information of a front link and information of a rear link of the object box having the link relationships with each of the two or more predicted tracks and recorded as the association candidate, among the plurality of object boxes.

The association scores may be determined based on at least one of a distance between a tracking point of each of the plurality of predicted tracks and a tracking point of each of the object boxes having the link relationships with the two or more predicted tracks, a proportion of a region in which each of the plurality of predicted tracks and each of the object boxes having the link relationships with the two or more predicted tracks, reliability of each of the plurality of predicted tracks, or an age of each of the plurality of predicted tracks.

The association scores may be determined further based on horizontal or vertical length comparison between a box representing each of the plurality of predicted tracks and each of the object boxes having the link relationships with the two or more predicted tracks, depending on position information of each of the plurality of predicted tracks in the previous step and position information of each of the plurality of predicted tracks in the current step.

In another embodiment of the present invention, a track association system for tracking objects includes a memory configured to store a plurality of track information generated in a previous step, and a controller electrically connected to the memory, wherein the controller generates a plurality of predicted tracks from the plurality of track information generated in the previous step and stored in the memory, generates link relationships between a plurality of object boxes detected in a current step and the plurality of predicted tracks, based on associations between the plurality of object boxes and the plurality of predicted tracks, determines, depending on association scores between an object box having the link relationships with two or more predicted tracks among the plurality of predicted tracks, and the two or more predicted tracks, one of the two or more predicted tracks, and associates the determined one of the two or more predicted tracks with a track of the object box having the link relationships.

The link relationships may be generated by recording an object box having the associations with each of the plurality of predicted tracks as an association candidate, and recording information of another predicted track having the associations with the association candidate.

The controller may sequentially match information of an object box determined as the association candidate of each of a first predicted track and a second predicted track included in the plurality of predicted tracks with each of the first predicted track and the second predicted track, may identify the first predicted track based on the information of the object box determined as the association candidate of the second predicted track, may match link information of the identified first predicted track with a front link of the object box determined as the association candidate of the second predicted track, and may match link information of the second predicted track to a rear link of the object box determined as the association candidate of the first predicted track.

The controller may identify the link information of the second predicted track matched with the rear link of the object box determined as the association candidate of the first predicted track, based on information of an object box determined as the association candidate of a third predicted track included in the plurality of predicted tracks, may identify a rear link of the object box determined as the association candidate of the second predicted track, based on the link information of the second predicted track, may match link information of the third predicted track with a rear link of the object box determined as the association candidate of the second predicted track based on a fact that any link information is not recorded in the rear link of the object box determined as the association candidate of the second predicted track, and may match the link information of the second predicted track to a front link of the object box determined as the association candidate of the third predicted track.

The two or more predicted tracks used as targets to calculate the association scores may be identified through information of a front link and information of a rear link of the object box having the link relationships with each of the two or more predicted tracks and recorded as the association candidate, among the plurality of object boxes.

The association scores may be determined based on at least one of a distance between a tracking point of each of the plurality of predicted tracks and a tracking point of each of the object boxes having the link relationships with the two or more predicted tracks, a proportion of a region in which each of the plurality of predicted tracks and each of the object boxes having the link relationships with the two or more predicted tracks, reliability of each of the plurality of predicted tracks, or an age of each of the plurality of predicted tracks.

The association scores may be determined further based on horizontal or vertical length comparison between a box representing each of the plurality of predicted tracks and each of the object boxes having the link relationships with the two or more predicted tracks, depending on position information of each of the plurality of predicted tracks in the previous step and position information of each of the plurality of predicted tracks in the current step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a diagram illustrating operation of a LiDAR signal processing system of a conventional vehicle;

FIG. 2 is a diagram illustrating an example of ideal association between a plurality of tracks for tracking a plurality of objects and a plurality of boxes generated so as to correspond to the plurality of objects;

FIG. 3 is a diagram illustrating an error in conventional association between tracks for tracking a plurality of objects and a plurality of boxes generated so as to correspond to the plurality of objects;

FIG. 4 is a block diagram showing the configuration of a vehicle including a track association system for tracking objects according to one embodiment of the present invention;

FIG. 5 is a flowchart representing operation of the system according to one embodiment of the present invention;

FIGS. 6 to 9 are diagrams illustrating operation of the system according to one embodiment of the present invention;

FIG. 10 is a flowchart representing operation of the track association system for tracking objects according to one embodiment of the present invention; and

FIGS. 11A and 11B and FIGS. 12A and 12B are diagrams showing results of the conventional association method between tracks and object boxes and an association method between tracks and object boxes according to one embodiment of the present invention.

### DETAILED DESCRIPTION OF ILLUSTRATIVE EMBODIMENTS

Reference will now be made in detail to embodiments of the present disclosure, examples of which are illustrated in the accompanying drawings. Wherever possible, the same reference numbers will be used throughout the drawings to refer to the same or like parts. All elements of the embodiments of the present invention are not described, and a description of content which is general in the art to which the present invention pertains or a description of redundant content among the embodiments will be omitted. As used herein, the terms “unit”, “module” and “device” may be implemented as software or hardware, and a plurality of units, modules or devices may be implemented as one element, or one unit, module or device may include a plurality of elements depending on embodiments.

In the following description of the embodiments, when an element or layer is referred to as being “connected to” or “coupled to” another element or layer, it may be directly connected or coupled to the other element or layer, or may be indirectly connected or coupled to the other element or layer, and indirect connection may encompass connection through a wireless communication network.

Further, the term “comprising” is inclusive and therefore specifies the presence of stated features, integers, steps, operations, elements, components, and/or combinations thereof, but does not preclude the presence or addition of one or more other features, integers, steps, operations, elements, components, and/or combinations thereof.

In the following description of the embodiments, terms, such as “first” and “second”, are used only to distinguish one element from other elements, and these elements should not be construed as being limited by these terms.

As used herein, singular forms may be intended to include plural forms as well, unless the context clearly indicates otherwise.

Identification marks in respective steps are used only for convenience of explanation, and do not imply a sequence or order of the respective steps, and the respective steps may be executed unlike the stated order, unless the context clearly indicates a specific order of the respective steps.

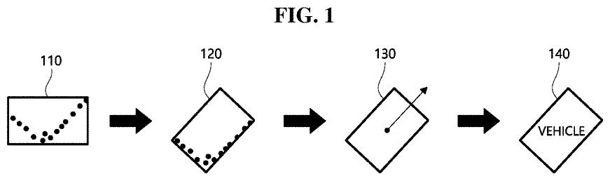

FIG. 1 is a diagram illustrating operation of a LiDAR signal processing system of a conventional vehicle.

Referring to FIG. 1, the LiDAR signal processing system of the conventional vehicle may perform a preprocessing and clustering operation 110 based on point data received from LiDAR of the vehicle.

The preprocessing and clustering operation 110 may include parsing the point data, removing point data corresponding to the ground from the entirety of the point data, and generating clusters by clustering point data expected to be included in the same object.

Further, the LiDAR signal processing system may perform a corresponding object detection operation 120 based on the clusters generated in the preprocessing and clustering operation 110.

The object detection operation 120 may include generating rectangular boxes (or referred to as object boxes or contours) by fitting corresponding shapes of the clusters on the respective objects, or generating contours based on the clustered point data.

Further, the LiDAR signal processing system may perform an object tracking operation 130 based on the boxes generated in the object detection operation 120.

The object tracking operation 130 may include generating tracks (or referred to as LiDAR tracks or predicted tracks) including position estimates corresponding to the objects so as to track the objects, calculating associations of the generated tracks with the generated boxes, and updating the generated tracks, i.e., updating the position estimates of the generated tracks corresponding to the objects. In addition, the object tracking operation 130 may include managing the updated tracks.

Further, the LiDAR signal processing system may perform an object classification operation 140 based on the updated tracks.

For example, the LiDAR signal processing system may classify the objects into a pedestrian, a guard rail, and/or a vehicle based on the tracks.

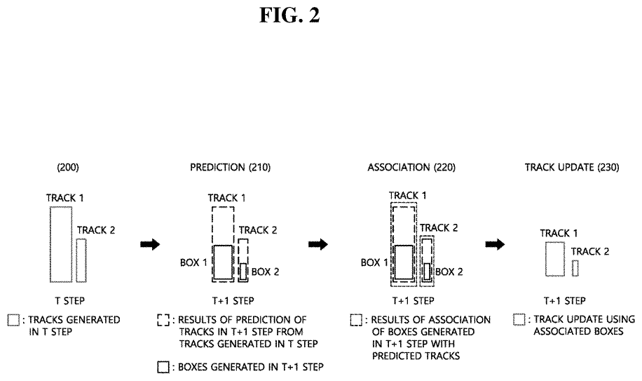

FIG. 2 is a diagram illustrating an example of ideal association between a plurality of tracks for tracking a plurality of objects and a plurality of boxes generated so as to correspond to the plurality of objects.

Referring to FIG. 2, the LiDAR signal processing system may perform a prediction operation 210, an association operation 220, and a track update operation 230 in step T+1, i.e., in the current step, in the state 200 in which a first track Track 1 and a second track Track 2 have been generated in step T, i.e., the previous step.

The LiDAR signal processing system may predict the first track and the second track, generated in step T, in step T+1, i.e., may predict the positions of the first track and the second track, generated in step T, in step T+1, due to performance of the prediction operation 210 in step T+1.

For example, the first track may be a predicted track generated to track the position of a first object, and the second track may be a predicted track generated to track the position of a second object.

In addition, the LiDAR signal processing system may generate a first box Box 1 corresponding to the first object, and a second box Box 2 corresponding to the second object in step T+1.

The LiDAR signal processing system may associate the expected first track with the first box corresponding thereto, and may associate the expected second track with the second box corresponding thereto, due to performance of the association operation 220 in step T+1. Here, for example, the first track may have a higher priority in the association operation 220 than the second track.

The LiDAR signal processing system may update the first track based on the first box associated with the first track, and may update the second track based on the second box associated with the second track, due to performance of the track update operation 230 in step T+1.

Results of processing due to operation of the above-described LiDAR signal processing system shown in FIG. 2 may indicate an example of an ideal update of the tracks.

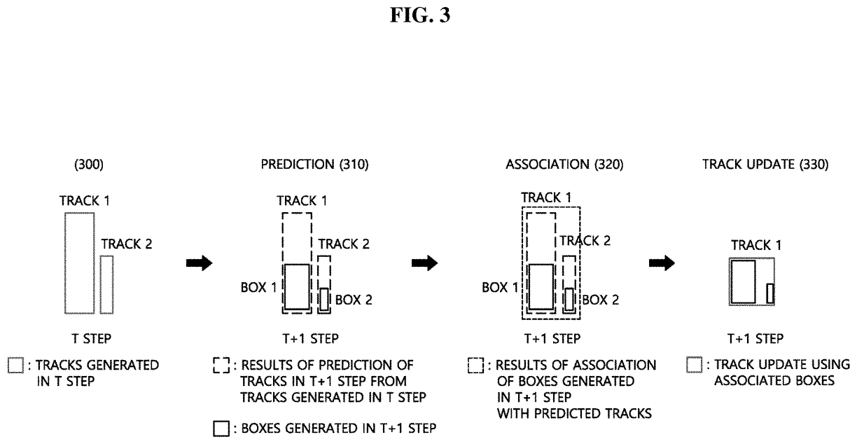

However, conventionally, other than the ideal results, as shown in FIG. 2, results of processing due to operation of the LiDAR signal processing system, as shown in FIG. 3, may be produced.

FIG. 3 is a diagram illustrating an error in conventional association between tracks for tracking a plurality of objects and a plurality of boxes generated so as to correspond to the plurality of objects.

Referring to FIG. 3, the LiDAR signal processing system may perform a prediction operation 310, an association operation 320, and a track update operation 330 in step T+1, in the state 300 in which a first track Track 1 and a second track Track 2 have been generated in step T.

The LiDAR signal processing system may predict the first track and the second track, generated in step T, in step T+1, i.e., may predict the positions of the first track and the second track, generated in step T, in step T+1, due to performance of the prediction operation 210 in step T+1.

For example, the first track may be a predicted track generated to track the position of a first object, and the second track may be a predicted track generated to track the position of a second object.

In addition, the LiDAR signal processing system may generate a first box Box 1 corresponding to the first object, and a second box Box 2 corresponding to the second object in the step T+1.

The LiDAR signal processing system may associate the first predicted track having a higher priority with both the first box and the second box based on determined priorities of the first track and the second track, due to performance of the association operation 320 in step T+1. Therefore, there is no box with which the second track is associated, and thus, the second track may be eliminated.

The LiDAR signal processing system may update the first track to a track for tracking the first object and the second object based on the first box and the second box associated with the first track, due to performance of the track update operation 330 in step T+1.

Results of processing due to operation of the above-described LiDAR signal processing system shown in FIG. 3 may indicate output of erroneous results of generation of a one-to-many association structure in which one track is associated with the box corresponding to a plurality of objects.

That is to say, since the priorities of the respective tracks are conventionally determined based on the reliabilities of the respective tracks, the first track and the second track are not respectively associated with the first box and the second box one-to-one, and the first track having a higher priority is associated with both the first box and the second box and thus consequently, erroneous results are output.

Therefore, the embodiments of the present invention provide a track association method and system for tracking objects of a vehicle which may prevent generation of an erroneous situation causing the conventional one-to-many association structure in which one track is associated with a plurality of boxes (or referred to as object boxes) corresponding to a plurality of objects.

For example, the embodiments of the present invention provide a track association method and system for tracking objects of a vehicle which may output the ideal results, as shown in FIG. 2.

Hereinafter, the operational principle and the embodiments of the present invention will be described with reference to the accompanying drawings.

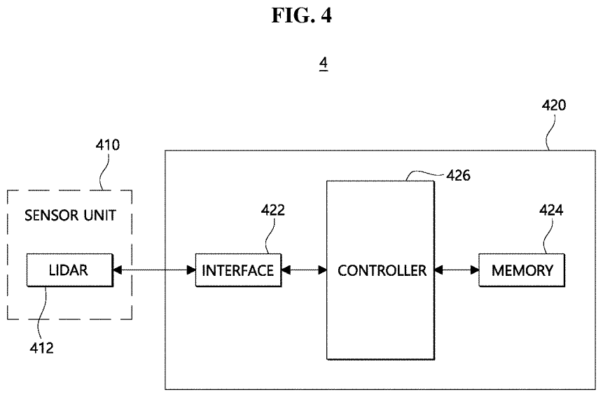

FIG. 4 is a block diagram showing the configuration of a vehicle including a track association system for tracking objects according to one embodiment of the present invention.

Referring to FIG. 4, a vehicle 4 may include a sensor unit 410 and a track association system 420 configured to track objects of the vehicle 4.

The sensor unit 410 may acquire sensor data corresponding to surrounding information of the vehicle 4, and may include at least one LiDAR 412.

One LiDAR 412 or a plurality of LiDARs 412 may be provided, and the LiDAR 412 may be mounted on the outer surface of the main body of the vehicle 4, and may radiate a laser pulse towards the surrounding of the vehicle 4 so as to generate LiDAR data, i.e., point data.

The track association system 420 may include an interface 422, a memory 424 and/or a controller 426.

The interface 422 may transmit commands input from other external devices or by a user to other elements of the track association system 420, or may output commands or data received from other elements of the track association system 420 to other external devices.

The memory 424 may store various data used by at least one element of the track association system 420, for example, input data and/or output data of software programs and commands related thereto.

The memory 424 may include a non-volatile memory, such as a cache, a Read Only Memory (ROM), a Programmable ROM (PROM), an Erasable Programmable ROM (EPROM), an Electrically Erasable Programmable ROM (EEPROM) and/or a flash memory, and/or a volatile memory, such as a Random Access Memory (RAM).

The controller 426 (or referred to as a control circuit or a processor) may control at least one of other elements (for example: hardware elements (for example: the interface 422 and/or the memory 424) and/or software elements (software programs) of the track association system 420, and perform various data processing and calculations. The controller 426 may include a processor and a memory.

The controller 426 may receive point data from the LiDAR 412 through the interface 422. Further, the controller 426 may generate clusters respectively corresponding to a plurality of objects by performing preprocessing and clustering based on the received point data. Further, the controller 426 may generate rectangular boxes, i.e., a plurality of object boxes, respectively corresponding to the plurality of objects by fitting corresponding shapes of the clusters on the respective objects.

Further, the controller 426 may generate tracks, i.e., predicted tracks, including position estimates corresponding to the objects so as to track the corresponding objects, based on the plurality of object boxes.

Moreover, the controller 426 may associate the generated predicted tracks with the corresponding object boxes.

According to one embodiment, the controller 426 may identify a plurality of track information generated in a previous step, i.e., at a previous point in time, and stored in the memory 424. For example, the plurality of track information generated in the previous step may include position estimates of the plurality of objects in the previous step.

The controller 426 may generate a plurality of predicted tracks in a current step, i.e., at a current point in time, from the plurality of track information generated in the previous step and stored in the memory 424.

Further, the controller 426 may detect a plurality of object boxes respectively corresponding to the plurality of objects in the current step. For example, the controller 426 may generate a plurality of object boxes respectively corresponding to the plurality of objects by generating clusters corresponding to the plurality of objects in the current step.

In addition, the controller 426 may determine associations between the plurality of object boxes detected in the current step and the plurality of predicted tracks in the current step, and may generate link relationships between the plurality of object boxes and the plurality of predicted tracks based on the determined associations therebetween.

The link relationships between the plurality of object boxes and the plurality of predicted tracks may be generated by recording object boxes having the association with each of the plurality of predicted tracks association candidates, and recording information of other predicted tracks having the associations with the association candidates.

For example, the controller 426 may determine object boxes having the association with each of the plurality of predicted tracks, among the plurality of object boxes, as association candidates of each of the plurality of predicted tracks. Further, the controller 426 may match the information of the object boxes determined as the association candidates with each of the plurality of predicted tracks, and may record, i.e., store, such matching information in the memory 424. Moreover, the controller 426 may match the link information of a corresponding track having the association with the front link or the rear link of each of the object boxes determined as the association candidates, and may record such matching information in the memory 424.

For example, with the front link of a first object box determined as the association candidate of a specific predicted track, the link information of another predicted track set to have link relationships with the first object box may be matched at a point in time just before the point in time when link relationships between the specific predicted track and the first object box are set.

Further, with the rear link of the first object box determined as the association candidate of the specific predicted track, the link information of yet another predicted track set to have link relationships with the first object box may be matched at a point in time just after the point in time when the link relationships between the specific predicted track and the first object box is set.

For example, on the assumption that the plurality of predicted tracks includes a first predicted track, a second predicted track and a third predicted track, and the first object box is determined as the association candidate of each of the first predicted track, the second predicted track and the third predicted track, the controller 426 may be operated using the following sequential method.

The controller 426 may match the information of the first object box with the association candidate of the first predicted track, and may store such matching information. Further, the controller 426 may include the information of the first predicted track, indicating that the first predicted track is initially associated with the first object box, in the information of the first object box.

Thereafter, the controller 426 may match the information of the first object box with the association candidate of the second predicted track, may store such matching information, and may identify the information of the first predicted track recorded as being initially associated with the first object box, based on the information of the first object box.

Accordingly, the controller 426 may match link information of the first predicted track with a front link of the first object box which is the association candidate of the second predicted track, and may store such matching information. Further, the controller 426 may match link information of the second predicted track with a rear link of the first object box which is the association candidate of the first predicted track.

Thereafter, the controller 426 may match the information of the first object box with the association candidate of the third predicted track, may store such matching information, and may identify the information of the first predicted track recorded as being initially associated with the first object box, based on the information of the first object box.

Further, the controller 426 may identify that the rear link of the first object box which is the association candidate of the first predicted track is the link information of the second predicted track, based on the identified information of the first predicted track.

Moreover, the controller 426 may identify that the front link of the first object box which is the association candidate of the second predicted track is the first predicted track and the rear link of the first object box is in a state in which no link information is recorded (or in a state in which the rear link is not set (for example: zero (0)), may match link information of the third predicted track with the rear link of the first object box which is the association candidate of the second predicted track, and may store such matching information.

Further, the controller 426 may match the link information of the second predicted track with the front link of the first object box which is the association candidate of the third predicted track, and may store such matching information.

Depending on operation of the controller 426 according to this embodiment, link relationships between a plurality of predicted tracks and a plurality of object boxes may be generated based on associations therebetween, and may be stored, i.e., recorded, in the memory 424.

Due to generation and storage of these link relationships, the memory 424 of the track association system 420 may be minimized in storage capacity, and may rapidly perform calculation through quick data access.

For example, compared to a general method in which information of all object boxes associated with each of predicted tracks, according to this embodiment of the present invention, link information of data is stored, and thereby, quick data access through the link information and minimization of the storage capacity of the memory 424 may be achieved.

Further, the controller 426 may calculate association scores between object boxes having the generated link relationships with two or more predicted tracks, among a plurality of predicted tracks, and the two or more corresponding predicted tracks.

For example, the controller 426 may identify information of a front link and information of a rear link of each of object boxes which have link relationships with two or more predicted tracks, among the plurality of predicted tracks, and are recorded as the association candidates of the two or more predicted tracks, and may identify the two or more corresponding predicted tracks, association scores of which with each object box are to be calculated, based on the identified information.

For example, the controller 426 may calculate the association scores based on the following predetermined conditions.

The conditions for calculating the association scores may include a distance (for example, a Mahalanobis generalized distance) between the tracking point of each of the two or more predicted tracks and the tracking point of the object box.

For example, the memory 424 may store predetermined score information (or referred to as first score information) corresponding to respective distances between the tracking point of the predicted track and the tracking point of the object box.

For example, a score of +20 when a distance between the tracking point of the predicted track and the tracking point of the object box is equal to or less than 0.1 m, a score of +16 when the distance between the tracking point of the predicted track and the tracking point of the object box is equal to or less than 0.2 m, a score of +14 when the distance between the tracking point of the predicted track and the tracking point of the object box is equal to or less than 0.3 m, a score of +8 when the distance between the tracking point of the predicted track and the tracking point of the object box is equal to or less than 0.4 m, a score of +6 when the distance between the tracking point of the predicted track and the tracking point of the object box is equal to or less than 0.5 m, a score of +4 when the distance between the tracking point of the predicted track and the tracking point of the object box is equal to or less than 0.6 m, and a score of −5 when the distance between the tracking point of the predicted track and the tracking point of the object box is equal to or greater than 0.8 m may be predetermined and stored in the memory 424.

The controller 426 may calculate the association scores of each of the two or more predicted tracks with the corresponding object box, based on the first score information stored in the memory 424 and results of calculation of the distance between the tracking point of each of the two or more predicted tracks and the tracking point of the corresponding object box.

Further, the conditions for calculating the association scores may include the proportion of a region in which each of the two or more predicted tracks and the object box overlap each other.

For example, the memory 424 may store predetermined score information (or referred to as second score information) corresponding to respective proportions of the region in which the predicted track and the object box overlap each other.

For example, a score of +8 when the proportion of the region in which the predicted track and the object box overlap each other is equal to or greater than 80%, a score of +4 when the proportion of the region is equal to or greater than 50%, and a score of +2 when the proportion of the region in which the predicted track and the object box overlap each other is equal to or greater than 20% may be predetermined and stored in the memory 424.

The controller 426 may calculate the association scores of each of the two or more predicted tracks with the corresponding object box, based on the second score information stored in the memory 424 and the proportion of the region in which the predicted track and the object box overlap each other.

Further, the conditions for calculating the association scores may include reliabilities of the predicted tracks.

For example, the memory 424 may store predetermined score information (or referred to as third score information) corresponding to respective reliabilities of the predicted track.

For example, a score of +6 when the reliability of the predicted track is equal to or greater than 80, and a score of +2 when the reliability of the predicted track is equal to or greater than 50 may be predetermined and stored in the memory 424.

The controller 426 may calculate the association scores of each of the two or more predicted tracks with the corresponding object box, based on the third score information stored in the memory 424 and the reliabilities of the predicted tracks.

Further, the conditions for calculating the association scores may include a horizontal or vertical length comparison between a box representing each of the two or more predicted tracks and the object box depending on the position information of the corresponding predicted track in the previous step and the position information of the corresponding predicted track in the current step.

Such comparison information may be comparison information between the length of each of the two or more predicted tracks and the length of the object box when the corresponding predicted track is moved laterally, and may be comparison information between the width of each of the two or more predicted tracks and the width of the object box when the corresponding predicted track is moved straight.

That is to say, whether the predicted track is moved laterally or moved straight may be determined depending on the position information of the predicted track in the previous step and the position information of the predicted track in the current step. Further, the horizontal length of the box representing the predicted track and the horizontal length of the object box may indicate the length of the predicted track and the length of the object box, and the vertical length of the box representing the predicted track and the vertical length of the object box may indicate the width of the predicted track and the width of the object box.

For example, the memory 424 may store predetermined score information (or referred to as fourth score information) corresponding to respective length or width differences between the predicted track and the object box.

For example, a score of +8 when the length or width of the predicted track and the length or width of the object box are different by 10% or less, and a score of +4 when the length or width of the predicted track and the length or width of the object box are different by 20% or less may be predetermined and stored in the memory 424.

The controller 426 may calculate the association scores of each of the two or more predicted tracks with the corresponding object box, based on the fourth score information stored in the memory 424 and the lengths or the widths of the predicted tracks and the object box.

Further, the conditions for calculating the association scores may include the ages of the two or more predicted tracks. Here, the age may indicate the length of a time taken to track a target object. That is to say, the age may indicate the number of time steps (or referred to as steps) at which the identification information of the predicted track is maintained.

For example, the memory 424 may store predetermined score information (or referred to as fifth score information) corresponding to respective ages of the predicted track.

For example, a score of −5 when the age of the predicted track is 1 may be predetermined and stored in the memory 424.

For example, when the age of the predicted track is 1, the score of −5 may be predetermined and stored in the memory 424.

The controller 426 may calculate the association score of each of the two or more predicted tracks with the corresponding object box, based on the fifth score information stored in the memory 424 and the ages of the two or more predicted tracks.

The controller 426 may finally calculate the association score of each of the two or more predicted tracks with the corresponding object box based on the above-described first score information, second score information, third score information, fourth score information and/or fifth score information.

Further, the controller 426 may determine one of the two or more corresponding predicted tracks depending on the calculated association scores, and may associate the determined predicted track with the track of the corresponding object box having the generated link relationships with the determined predicted track.

That is to say, the controller 426 may finally associate one predicted track having the highest association score with the track of the corresponding object box.

Due to such operation of the controller 426, when one object box has associations with a plurality of predicted tracks, one predicted track having the highest association with the corresponding object box may be selected from among the plurality of predicted tracks, and may be associated with the track of the corresponding object box.

Hereinafter, an embodiment of detailed operation of the track association system 420 under the control of the controller 426 will be described with reference to the accompanying drawings.

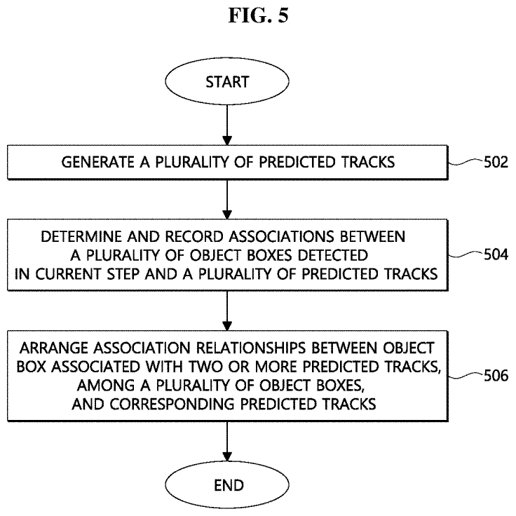

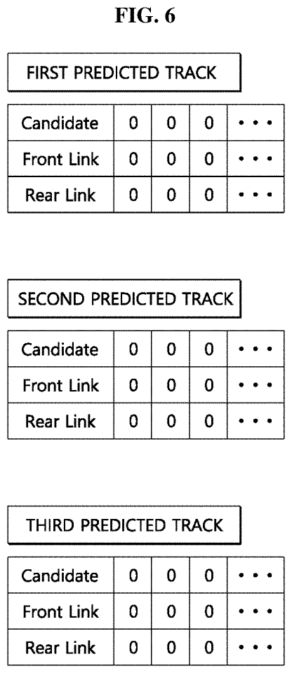

FIG. 5 is a flowchart representing operation of the track association system 420 for tracking objects of the vehicle 4 (and/or the controller 426 of the track association system 420) according to one embodiment of the present invention. FIGS. 6 to 9 are diagrams illustrating operation of the track association system 420 for tracking objects of the vehicle 4 (and/or the controller 426 of the track association system 420) according to one embodiment of the present invention.

Referring to FIG. 5, the track association system 420 may generate a plurality of predicted tracks from a plurality of track information generated in the previous step (502).

The plurality of predicted tracks may be generated by predicting the positions of tracks, which were generated and maintained in the previous step, in the current step.

The track association system 420 may generate the plurality of predicted tracks by predicting tracks in the current step from the tracks, which were generated and maintained in the previous step, based on the relative speeds of the tracks, the speed of the vehicle 4 and/or the yaw rate of the vehicle 4.

A method for predicting tracks in the current step from the tracks generated and maintained in the previous step is well-known technology, and a detailed description thereof will thus be omitted.

The track association system 420 may calculate associations between a plurality of object boxes detected in the current step and the plurality of predicted tracks, and may record the calculated associations (504).

The track association system 420 may calculate the association between each of the plurality of object boxes detected and each of the plurality of predicted tracks, based on various well-known technologies, such as position comparison and/or region comparison between each of the plurality of object boxes and each of the plurality of predicted tracks.

The track association system 420 may record an association relationship between a corresponding object box and a corresponding predicted track in the memory 424, when a calculated association satisfies a predetermined reference.

For example, the track association system 420 may sequentially generate relationships between the plurality of predicted tracks and a specific object box, and may store, i.e., record, the generated relationships in the memory 424, as shown in FIGS. 6 to 9.

Referring to FIG. 6, the track association system 420 may allocate arrangement spaces (or referred to as designated memory blocks), with which information of an object box serving as an association candidate (or referred to as identification information of the object box) may be matched, to each of the plurality of predicted tracks (for example, a first predicted track, a second predicted track and a third predicted track).

Further, the track association system 420 may allocate arrangement spaces of a front link and a rear link corresponding to respective information of the object box which become each association candidate.

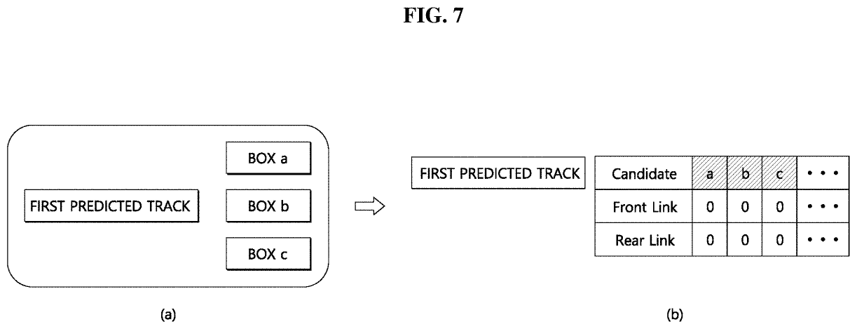

Referring to FIG. 7, when the track association system 420 determines that the first predicted track has associations with box a, box b and box c, as shown in step (a) of FIG. 7, the track association system 420 may match box a, box b and box c with object boxes serving as association candidates of the first predicted track, and may store, i.e., record, such matching information in the memory 424, as shown in step (b) of FIG. 7.

Referring to step (b) of FIG. 7, the track association system 420 may record a, b and c, i.e., the identification information of box a, box b and box c, as the information of the object boxes serving as the association candidates of the first predicted track.

Further, although not shown in these figures, as setting of association relationships between a predicted track and object boxes serving as association candidates is initially started, the track association system 420 may store the fact that the information of the first predicted track is initially associated with box a, box b and box c in the information of each of box a, box b and box c.

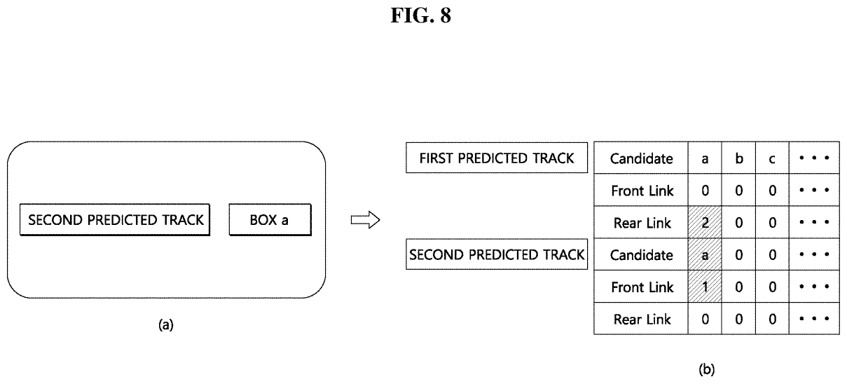

Referring to FIG. 8, when the track association system 420 determines that the second predicted track has an association with box a, as shown in step (a) of FIG. 8, the track association system 420 may match box a with an object box serving as an association candidate of the second predicted track, and may store, i.e., record, such matching information in the memory 424, as shown in step (b) of FIG. 8.

Referring to step (b) of FIG. 8, the track association system 420 may record box a, i.e., the identification information of box a, as the information of the object box serving as the association candidate of the second predicted track.

Further, the track association system 420 may identify that the information of the first predicted track is initially associated with box a, based on the information of box a. Through such identifying, the track association system 420 may match the link information of the first predicted track, i.e., 1, with the front link of box a which is the object box serving as the association candidate of the second predicted track, and may then record 1. Further, the track association system 420 may match the link information of the second predicted track, i.e., 2, with the rear link of box a serving as the association candidate of the first predicted track, and may then record 2.

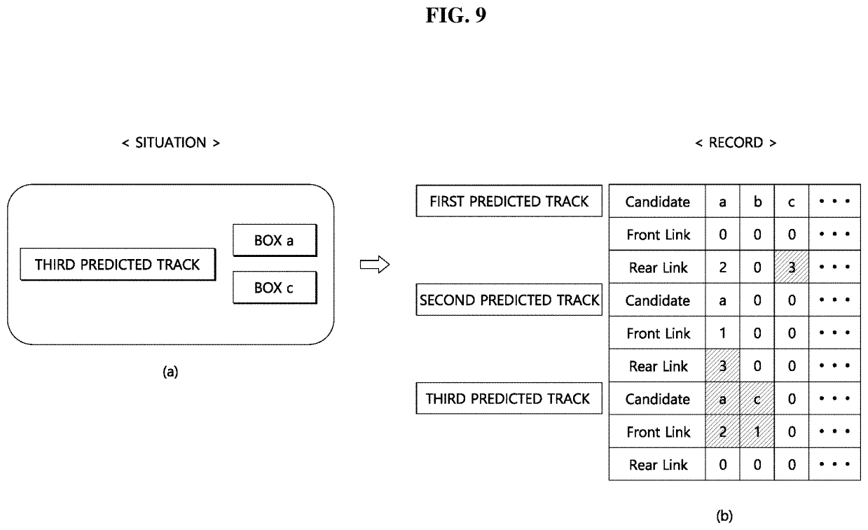

Referring to FIG. 9, when the track association system 420 determines that the third predicted track has associations with box a and box c, as shown in step (a) of FIG. 9, the track association system 420 may match box a and box c with object boxes serving as association candidates of the third predicted track, and may store such matching information in the memory 424, as shown in step (b) of FIG. 9.

Further, the track association system 420 may identify that the rear link of box a recorded as the association candidate of the first predicted track is the second predicted track, by accessing the first predicted track based on the information of box a. The track association system 420 may identify that the front link of box a recorded as the association candidate of the second predicted track is the first predicted track and the rear link of box a is not recorded now, by accessing the second predicted track which is the rear link of box a recorded as the association candidate of the first predicted track.

Accordingly, the track association system 420 may match the link information of the third predicted track, i.e., 3, with the rear link of box a which is the object box serving as the association candidate of the second predicted track, and may then store, i.e., record, 3 in the memory 424. Further, the track association system 420 may match the link information of the second predicted track, i.e., 2, with the front link of box a which is the object box serving as the association candidate of the third predicted track, and may then record 2.

Further, the track association system 420 may identify that the information of the first predicted track is initially associated with box c, based on the information of box c recorded as the association candidate of the first predicted track. Through such identifying, the track association system 420 may match the link information of the first predicted track, i.e., 1, with the front link of box c which is the object box serving as the association candidate of the third predicted track, and may then record 1. Further, the track association system 420 may match the link information of the third predicted track, i.e., 3, with the rear link of box c serving as the association candidate of the first predicted track, and may then record 3.

The track association system 420 may arrange association relationships between each of object boxes associated with two or more predicted tracks, among the plurality of object boxes, and the two or more corresponding predicted tracks (506).

The track association system 420 may calculate association scores between each of object boxes associated with two or more predicted tracks, among a plurality of object boxes, and the two or more corresponding predicted tracks, based on the predetermined conditions, and may determine one of the two or more corresponding predicted tracks.

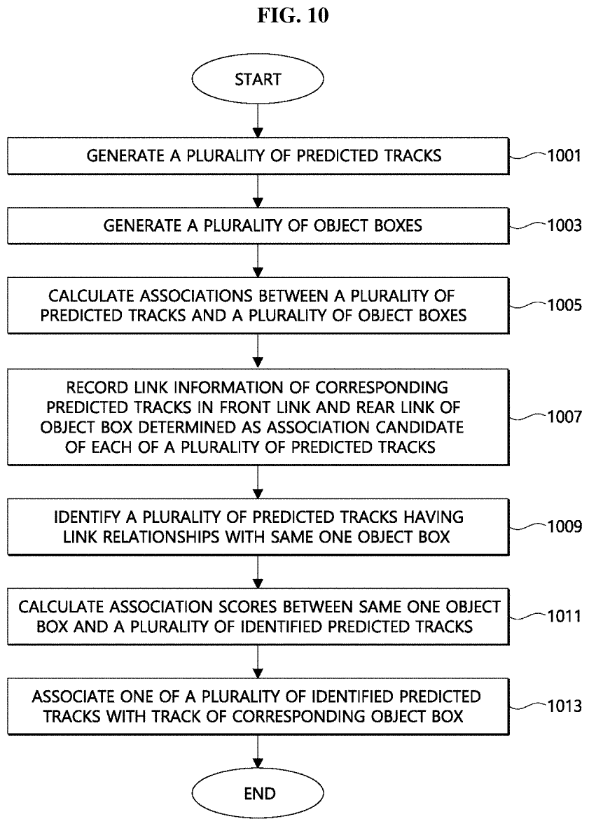

FIG. 10 is a flowchart representing operation of the track association system 420 for tracking objects (and/or the controller 426 of the track association system 420) according to one embodiment of the present invention.

Referring to FIG. 10, the track association system 420 may generate a plurality of predicted tracks in the current step, from information regarding a plurality of tracks generated in the previous step (1001).

The track association system 420 may generate a plurality of object boxes corresponding to a plurality of objects in the current step (1003).

The track association system 420 may calculate associations between the plurality of predicted tracks and the plurality of object boxes (1005).

The track association system 420 may record link information of the corresponding predicted tracks in the front links and the rear links of the object boxes determined as the association candidates of each of the plurality of predicted tracks, based on the calculated associations (1007).

The track association system 420 may determine the association candidates of each of the plurality of predicted tracks, based on the associations between the plurality of predicted tracks and the plurality of object boxes. Further, the track association system 420 may sequentially match the link information of the corresponding predicted tracks with the front links and the rear links of the object boxes determined as the association candidates of each of the plurality of predicted tracks, and may record the matched link formation, thereby being capable of generating link relationships between the plurality of predicted tracks and the plurality of object boxes.

The track association system 420 may identify a plurality of predicted tracks having the link relationships with the same one object box, based on the link relationships generated in Operation 1007 (1009).

For example, the track association system 420 may identify two or more predicted tracks having the link relationships with the same one object box by identifying object boxes having the link relationships with two or more predicted tracks that have been generated, among the plurality of object boxes.

The track association system 420 may calculate association scores between the same one object box and the two or more identified predicted tracks (1011).

For example, the track association system 420 may calculate association scores between each of the object boxes having the link relationships with the two or more predicted tracks, and the corresponding two or more predicted tracks, based on conditions predetermined to calculate the associations therebetween.

The track association system 420 may associate one of the two or more identified predicted tracks with the track of the corresponding object box based on the association scores (1013).

For example, the track association system 420 may associate one predicted track having the highest association score among the two or more identified predicted tracks, based on the association scores between the object boxes having the link relationships with the two or more predicted tracks, and the corresponding two or more predicted tracks.

The above-described embodiment of the present invention may replace the conventional one-to-many association method between a track provided to maintain track identification information and object boxes with the many-to-many association method. Therefore, embodiments of the present invention may improve performance to track the tracks configured to track objects, i.e., performance to maintain the track identification information, and may minimize a calculation time using link relationships, i.e., using a linked list method.

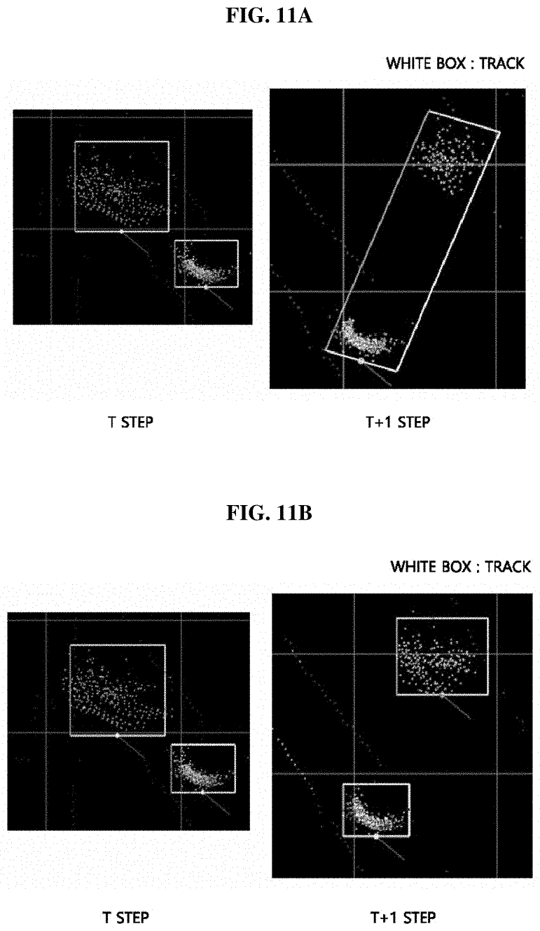

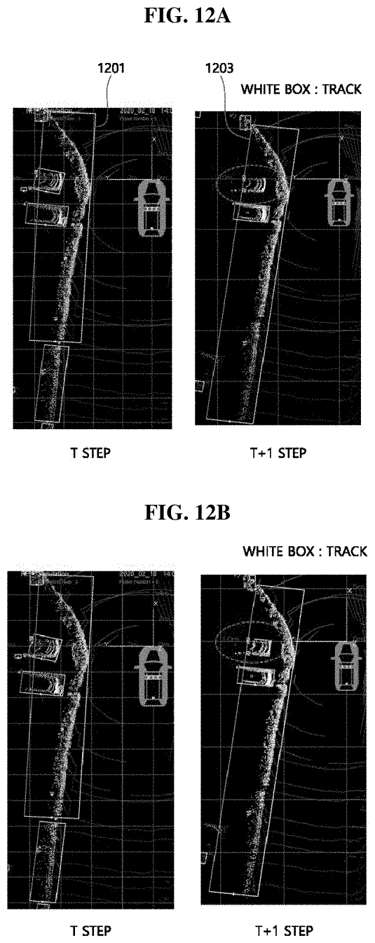

FIGS. 11A and 11B and FIGS. 12A and 12B are diagrams showing results of the conventional association method between tracks and object boxes and an association method between tracks and object boxes according to one embodiment of the present invention.

Referring to FIGS. 11A and 11B, conventionally, two tracks for a pedestrian and a street lamp respectively are generated at step T, as shown in FIG. 11A, but one track for the entirety of the pedestrian and the street lamp may be generated at step T+1, as shown in FIG. 11A. Such a problem may be caused because any one of two tracks predicted at step T+1 is associated with two detected boxes adjacent to each other.

In order to solve the above conventional problem, the above-described track association system 420 according to one embodiment of the present invention may perform association operation by identifying all associations between two predicted tracks, generated from track information at step T, and two detected object boxes at step T+1. Therefore, after the track association system 420 generates two tracks for a pedestrian and a street lamp respectively at step T, as shown in FIG. 11B, the track association system 420 may maintain the two tracks for the pedestrian and the street lamp respectively at step T+1, as shown in FIG. 11B.

Referring to FIGS. 12A and 12B, conventionally, a track 1201 indicating a vehicle is generated at step T, but the track 1201 indicating the vehicle may not be maintained at step T+1, as shown in FIG. 12A. Such a problem may be caused because reliability of a track 1203 indicating bushes is higher than reliability of tracks indicating other objects.

In order to solve the above conventional problem, the above-described track association system 420 according to one embodiment of the present invention may perform an association operation by identifying all associations between all predicted tracks, generated from track information at step T, and all detected object boxes at step T+1.

Therefore, after the track association system 420 generates tracks for respective objects including vehicles at step T, as shown in FIG. 12B, the track association system 420 may maintain the tracks for the respective objects including the vehicles at step T+1, as shown in FIG. 12B.

The above-described embodiments may be implemented in the form of recording media in which commands executable by computers are stored. The commands may be stored in the form of program code, and may generate program modules and may thus perform operations of the disclosed embodiments when the commands are executed by a processor. The recording media may be implemented as computer readable recording media.

The computer readable recording media may include all kinds of recording media in which commands readable by computers are stored. For example, the computer readable recording media may include a Read Only Memory (ROM), a Random Access Memory (RAM), a magnetic tape, a magnetic disk, a flash memory, an optical data storage device, etc.

As is apparent from the above description, a track association method and system for tracking objects according to embodiments of the present invention may replace the conventional one-to-many association method between a track provided to maintain track identification information and object boxes with the many-to-many association method, thereby being capable of improving performance to maintain track identification information.

Further, the track association method and system for tracking objects according to embodiments of the present invention may apply a linked list method to implementation of a many-to-many association structure between tracks and object boxes corresponding to objects, thereby being capable of minimizing a calculation time and minimizing the capacity of a memory.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for tracking objects, the method comprising:
generating a plurality of predicted tracks from a plurality of track information generated in a previous step;
generating link relationships between a plurality of object boxes detected in a current step and the plurality of predicted tracks, based on associations between the plurality of object boxes and the plurality of predicted tracks; and
determining one of the two or more predicted tracks, based on association scores between the two or more predicted tracks and an object box having the link relationships with two or more predicted tracks among the plurality of predicted tracks, and associating the determined one of the two or more predicted tracks with a track of the object box having the link relationships.

2. The method according to claim 1, wherein the link relationships are generated by recording an object box having the associations with each of the plurality of predicted tracks as an association candidate, and recording information of a second predicted track having the associations with the association candidate.

3. The method according to claim 2, wherein generating the link relationships comprise:
sequentially matching information of an object box determined as the association candidate of each of a first predicted track and a second predicted track included in the plurality of predicted tracks with each of the first predicted track and the second predicted track;
identifying the first predicted track based on the information of the object box determined as the association candidate of the second predicted track;
matching link information of the identified first predicted track with a front link of the object box determined as the association candidate of the second predicted track; and
matching link information of the second predicted track to a rear link of the object box determined as the association candidate of the first predicted track.

4. The method according to claim 3, wherein generating the link relationships further comprise:
identifying the link information of the second predicted track matched with the rear link of the object box determined as the association candidate of the first predicted track, based on information of an object box determined as the association candidate of a third predicted track included in the plurality of predicted tracks;
identifying a rear link of the object box determined as the association candidate of the second predicted track, based on the link information of the second predicted track; and
matching link information of the third predicted track with the rear link of the object box determined as the association candidate of the second predicted track based on a fact that any link information is not recorded in the rear link of the object box determined as the association candidate of the second predicted track, and matching the link information of the second predicted track to a front link of the object box determined as the association candidate of the third predicted track.

5. The method according to claim 2, wherein the two or more predicted tracks used as targets to calculate the association scores are identified through information of a front link and information of a rear link of the object box having the link relationships with each of the two or more predicted tracks and recorded as the association candidate, among the plurality of object boxes.

6. The method according to claim 1, wherein the association scores are determined based on a distance between a tracking point of each of the plurality of predicted tracks and a tracking point of each of the object boxes having the link relationships with the two or more predicted tracks, a proportion of a region in which each of the plurality of predicted tracks and each of the object boxes having the link relationships with the two or more predicted tracks, reliability of each of the plurality of predicted tracks, or an age of each of the plurality of predicted tracks.

7. The method according to claim 6, wherein the association scores are determined further based on a horizontal or vertical length comparison between a box representing each of the plurality of predicted tracks and each of the object boxes having the link relationships with the two or more predicted tracks, depending on position information of each of the plurality of predicted tracks in the previous step and position information of each of the plurality of predicted tracks in the current step.

8. A system for tracking objects, the system comprising:
a memory configured to store a plurality of track information generated in a previous step; and
a controller electrically connected to the memory, wherein the controller is configured to:
generate a plurality of predicted tracks from the plurality of track information generated in the previous step and stored in the memory;
generate link relationships between a plurality of object boxes detected in a current step and the plurality of predicted tracks, based on associations between the plurality of object boxes and the plurality of predicted tracks; and
determine one of the two or more predicted tracks, based on association scores between the two or more predicted tracks and an object box having the link relationships with two or more predicted tracks among the plurality of predicted tracks, and associate the determined one of the two or more predicted tracks with a track of the object box having the link relationships.

9. The system according to claim 8, wherein the link relationships are generated by recording an object box having the associations with each of the plurality of predicted tracks as an association candidate, and recording information of a second predicted track having the associations with the association candidate.

10. The system according to claim 9, wherein the controller is configured to:
sequentially match information of an object box determined as the association candidate of each of a first predicted track and a second predicted track included in the plurality of predicted tracks with each of the first predicted track and the second predicted track;
identify the first predicted track based on the information of the object box determined as the association candidate of the second predicted track;
match link information of the identified first predicted track with a front link of the object box determined as the association candidate of the second predicted track; and
match link information of the second predicted track to a rear link of the object box determined as the association candidate of the first predicted track.

11. The system according to claim 10, wherein the controller is configured to:
identify the link information of the second predicted track matched with the rear link of the object box determined as the association candidate of the first predicted track, based on information of an object box determined as the association candidate of a third predicted track included in the plurality of predicted tracks;
identify a rear link of the object box determined as the association candidate of the second predicted track, based on the link information of the second predicted track; and
match link information of the third predicted track with a rear link of the object box determined as the association candidate of the second predicted track based on a fact that any link information is not recorded in the rear link of the object box determined as the association candidate of the second predicted track, and match the link information of the second predicted track to a front link of the object box determined as the association candidate of the third predicted track.

12. The system according to claim 9, wherein the two or more predicted tracks used as targets to calculate the association scores are identified through information of a front link and information of a rear link of the object box having the link relationships with each of the two or more predicted tracks and recorded as the association candidate, among the plurality of object boxes.

13. The system according to claim 8, wherein the association scores are determined based on a distance between a tracking point of each of the plurality of predicted tracks and a tracking point of each of the object boxes having the link relationships with the two or more predicted tracks, a proportion of a region in which each of the plurality of predicted tracks and each of the object boxes having the link relationships with the two or more predicted tracks, reliability of each of the plurality of predicted tracks, or an age of each of the plurality of predicted tracks.

14. The system according to claim 13, wherein the association scores are determined further based on a horizontal or vertical length comparison between a box representing each of the plurality of predicted tracks and each of the object boxes having the link relationships with the two or more predicted tracks, based on position information of each of the plurality of predicted tracks in the previous step and position information of each of the plurality of predicted tracks in the current step.

15. A vehicle comprising:
a vehicle body;
a sensor unit mounted on an outer surface of the vehicle body, the sensor unit comprising a LiDAR sensor;
a memory storing a program for tracking objects; and
a controller electrically connected to the memory, wherein the controller, when executing the program, is configured to:
generate a plurality of predicted tracks from a plurality of track information generated in a previous step and stored in the memory;
generate link relationships between a plurality of object boxes detected in a current step and the plurality of predicted tracks, based on associations between the plurality of object boxes and the plurality of predicted tracks; and
determine one of the two or more predicted tracks, based on association scores between the two or more predicted tracks and an object box having the link relationships with two or more predicted tracks among the plurality of predicted tracks, and associate the determined one of the two or more predicted tracks with a track of the object box having the link relationships.

16. The vehicle according to claim 15, wherein the link relationships are generated by recording an object box having the associations with each of the plurality of predicted tracks as an association candidate, and recording information of a second predicted track having the associations with the association candidate.

17. The vehicle according to claim 16, wherein the controller is configured to:
sequentially match information of an object box determined as the association candidate of each of a first predicted track and a second predicted track included in the plurality of predicted tracks with each of the first predicted track and the second predicted track;
identify the first predicted track based on the information of the object box determined as the association candidate of the second predicted track;
match link information of the identified first predicted track with a front link of the object box determined as the association candidate of the second predicted track; and
match link information of the second predicted track to a rear link of the object box determined as the association candidate of the first predicted track.

18. The vehicle according to claim 17, wherein the controller is configured to:
identify the link information of the second predicted track matched with the rear link of the object box determined as the association candidate of the first predicted track, based on information of an object box determined as the association candidate of a third predicted track included in the plurality of predicted tracks;
identify a rear link of the object box determined as the association candidate of the second predicted track, based on the link information of the second predicted track; and
match link information of the third predicted track with a rear link of the object box determined as the association candidate of the second predicted track based on a fact that any link information is not recorded in the rear link of the object box determined as the association candidate of the second predicted track, and match the link information of the second predicted track to a front link of the object box determined as the association candidate of the third predicted track.

19. The vehicle according to claim 15, wherein the association scores are determined based on a distance between a tracking point of each of the plurality of predicted tracks and a tracking point of each of the object boxes having the link relationships with the two or more predicted tracks, a proportion of a region in which each of the plurality of predicted tracks and each of the object boxes having the link relationships with the two or more predicted tracks, reliability of each of the plurality of predicted tracks, or an age of each of the plurality of predicted tracks.

20. The vehicle according to claim 19, wherein the association scores are determined further based on a horizontal or vertical length comparison between a box representing each of the plurality of predicted tracks and each of the object boxes having the link relationships with the two or more predicted tracks, based on position information of each of the plurality of predicted tracks in the previous step and position information of each of the plurality of predicted tracks in the current step.
